(19) United States
(12) Patent Application Publication
(10) Pub. No.: US 2013/0250108 A1
(43) Pub. Date: Sep. 26, 2013

(54) Access Control System by Face Recognition in An Automobile

(71) Applicant: O2MICRO, INC., Santa Clara, CA (US)

(72) Inventors: Sterling Shyundii Du, Shanghai (CN); Jingjing Zuo, Beijing (CN); Chengxia He, Chengdu (CN); Qi Zhu, Chengdu (CN)

(73) Assignee: O2MICRO, INC., Santa Clara, CA (US)

(21) Appl. No.: 13/757,098

(22) Filed: Feb. 1, 2013

(30) Foreign Application Priority Data
Mar. 20, 2012 (CN) 201210074024.2

(51) Int. Cl. G06K 9/00; G06F 21/32

(52) U.S. Cl. CPC G06K 9/00221; G06F 21/32
USPC 348/148

(57) ABSTRACT

An access control system in an automobile is provided. The access control system includes a grayscale camera, an infrared camera and a processing device. The grayscale camera is configured to capture a grayscale image of the face of a driver. The infrared camera is configured to capture an infrared image of the face of the driver simultaneously with the grayscale camera. The processing device includes a processor and a controller. The processor is configured to receive the grayscale image and the infrared image, convert the grayscale image and the infrared image to a grayscale matrix and an infrared matrix respectively, extract a feature matrix from the grayscale matrix and the infrared matrix, and compute a similarity value by comparing the feature matrix with multiple feature matrices. The controller is configured to receive a result of face recognition and control a startup device and a warning device of the automobile.

### RELATED APPLICATIONS

This application claims priority to Chinese Patent Application Number 201210074024.2, filed on Mar. 20, 2012 with State Intellectual Property Office of P.R. China (SIPO), which is hereby incorporated by reference.

### FIELD OF THE INVENTION

The present teaching relates to an access control system by face recognition and more particularly to an access control system by face recognition in an automobile.

### BACKGROUND

Face recognition is an emerging identification technology which can automatically identify the identity of a person based on the facial features of the person. Face recognition is carried out by extracting facial feature points of the image from a video based on a widely adopted regional characteristic analysis algorithm integrating with the computer image processing technology, and by further establishing a mathematical model utilizing relevant principles.

Generally, face recognition includes image capturing, face location, image preprocessing, face recognition (identification), etc. First, an image of a person is captured by a camera and a facial image is extracted from the captured image. A mathematical model is generated by preprocessing the facial image. Then the generated mathematical model is compared with multiple mathematical models stored in the face database and a similarity value is generated, based on which the identity of the person can be identified.

Conventionally, anyone can start an automobile with a key to the automobile, which increases the risk of an automobile being stolen. Furthermore, the owner of an automobile has no way to start it in the case of a key lost.

### SUMMARY

The present teaching relates to an access control system by face recognition and more particularly to an access control system by face recognition in an automobile.

In one embodiment, an access control system in an automobile is provided. The access control system includes a grayscale camera, an infrared camera and a processing device. The grayscale camera is configured to capture a grayscale image of the face of a driver. The infrared camera is configured to capture an infrared image of the face of the driver simultaneously with the grayscale camera. The processing device, coupled to the grayscale camera and the infrared camera, includes a processor and a controller. The processor is configured to receive the grayscale image captured by the grayscale camera and the infrared image captured by the infrared camera, convert the grayscale image and the infrared image to a grayscale matrix and an infrared matrix respectively, extract a feature matrix from the grayscale matrix and the infrared matrix, and compute a similarity value by comparing the feature matrix with multiple feature matrices representing facial information of authorized drivers to derive a result of face recognition. The controller is configured to receive the result of face recognition and control a startup device and a warning device of the automobile according to the result of face recognition.

In another embodiment, a face recognition system is provided. The face recognition system includes a grayscale camera, an infrared camera and a processor. The grayscale camera is configured to capture a grayscale image of a face. The infrared camera is configured to capture an infrared image of the face simultaneously with the grayscale camera. The processor is configured to receive the grayscale image captured by the grayscale camera and the infrared image captured by the infrared camera, convert the grayscale image and the infrared image to a grayscale matrix and an infrared matrix respectively, extract a feature matrix from the grayscale matrix and the infrared matrix, and compute a similarity value by comparing the feature matrix with multiple feature matrices of predetermined facial information to derive the result of face recognition.

In another embodiment, a method of face recognition is provided A grayscale image of a face is captured by a grayscale camera and an infrared image of the face is captured by an infrared camera simultaneously. The grayscale image and the infrared image are sent to a processor. The grayscale image is converted to a grayscale matrix and the infrared image is converted to an infrared matrix by the processor. A feature matrix is extracted from the grayscale matrix and the infrared matrix. A similarity value is computed by comparing the feature matrix with multiple feature matrices by the processor, and a result of face recognition is outputted according to the similarity value.

### BRIEF DESCRIPTION OF THE DRAWINGS

Features and advantages of embodiments of the claimed subject matter will become apparent as the following detailed description proceeds, and upon reference to the drawings, wherein like numerals depict like parts. These exemplary embodiments are described in detail with reference to the drawings. These embodiments are non-limiting exemplary embodiments, in which like reference numerals represent similar structures throughout the several views of the drawings.

FIG. 1 illustrates a block diagram of a face recognition system, according to one embodiment of the present disclosure;

FIG. 2 illustrates a process of getting a similarity value, according to one embodiment of the present disclosure;

FIG. 3 shows a flowchart of operations performed by a face recognition system, according to one embodiment of the present disclosure;

FIG. 4 shows an access control system by face recognition in an automobile, according to one embodiment of the present disclosure;

FIG. 5 shows an application scenario of an access control system by face recognition in an automobile, according to one embodiment of the present disclosure; and

FIG. 6 illustrates a block diagram of an access control system by face recognition in an automobile, according to one embodiment of the present disclosure.

### DETAILED DESCRIPTION

Reference will now be made in detail to the embodiments of the present teaching. While the present teaching will be described in conjunction with these embodiments, it will be understood that they are not intended to limit the present teaching to these embodiments. On the contrary, the present teaching is intended to cover alternatives, modifications and equivalents, which may be included within the spirit and scope of the present teaching as defined by the appended claims.

Furthermore, in the following detailed description of the present teaching, numerous specific details are set forth in order to provide a thorough understanding of the present teaching. However, it will be recognized by one of ordinary skill in the art that the present teaching may be practiced without these specific details. In other instances, well known methods, procedures, components, and circuits have not been described in detail as not to unnecessarily obscure aspects of the present teaching.

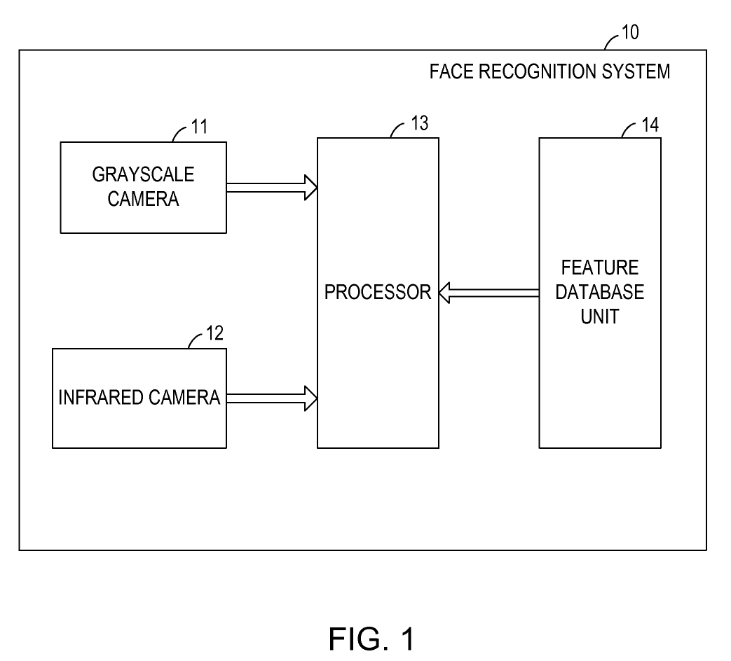

FIG. 1 illustrates a block diagram of a face recognition system, according to one embodiment of the present disclosure. The face recognition system 10 of the present teaching includes a grayscale camera 11, an infrared camera 12, a processor 13 and a feature database unit 14.

In one embodiment, the grayscale camera 11 is configured to capture a grayscale image of the face of a person and send the captured grayscale image to the processor 13. In the present teaching, by using the grayscale camera 11, the captured grayscale image can have relatively small image size, therefore, the amount of computation and the storage space in the face recognition system 10 can be effectively reduced without impacting the correctness of the recognition result. Preferably, the grayscale camera 11 captures the grayscale image at a frequency of 2 to 3 frames per second.

However, light is essential in the process of capturing image by the grayscale camera 11. The grayscale of the captured image varies greatly with the variation of light, which can cause errors and affect the result of face recognition. Therefore, according to the present teaching, the face recognition system 10 utilizes the infrared camera 12 to capture an infrared image of the face simultaneously with the grayscale camera 11. Furthermore, the captured infrared image is sent to the processor 13 for further processing. Preferably, the infrared camera 12 captures the infrared image at a frequency of 2 to 3 frames per second.

One of ordinary skill in the art should understand that the infrared image captured by the infrared camera 12 does not rely on the light. Therefore, errors caused by the light can be avoided by sending both the grayscale image captured by the grayscale camera 11 and the infrared image captured by the infrared camera 12 to the processor 13 for processing simultaneously. And the recognition result can be more accurate.

The processor 13 receives the grayscale image captured by the grayscale camera 11 and the infrared image captured by the infrared camera 12, converts each of the grayscale image and the infrared image to a matrix, extracts a feature matrix representing the facial information from the two converted matrices, computes a similarity value with a series of algorithms, and output the result of face recognition according to the similarity value. In one embodiment, the processor 13 obtains the similarity value by comparing the extracted feature matrix with multiple facial information feature matrices stored in the feature database unit 14. If the similarity value is less than a predetermined threshold, the person is unauthorized. On the other hand, if the similarity value is greater than or equal to the predetermined threshold, the person is authorized.

The feature database unit 14, also known as experience database unit, stores facial information feature matrices, i.e., feature matrices of predetermined facial information.

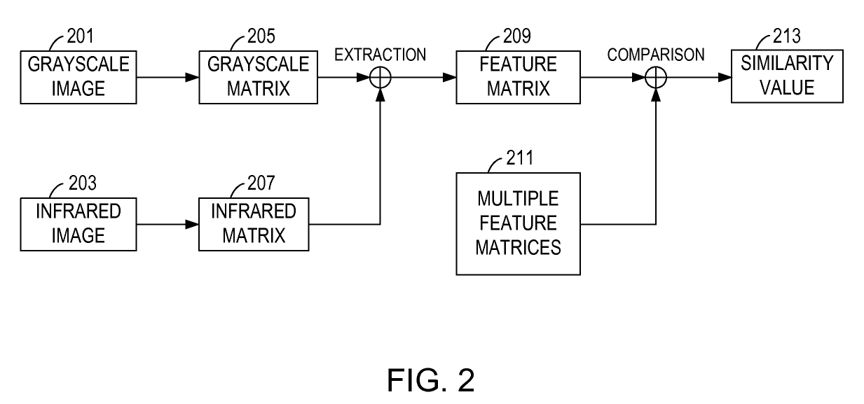

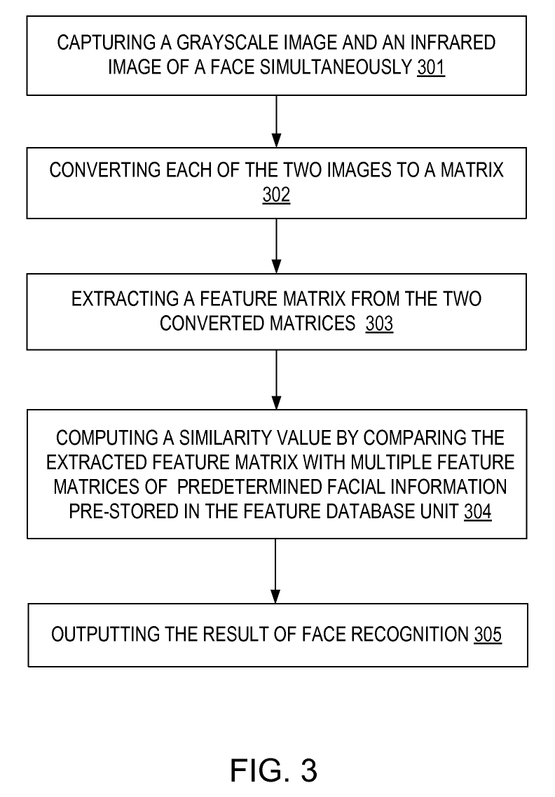

FIG. 2 illustrates a process of getting a similarity value, according to one embodiment of the present disclosure. FIG. 3 shows a flowchart of operations performed by a face recognition system, in accordance with one embodiment of the present teaching. According to the present teaching, the operations performed by the face recognition system include the procedures of image capturing, image conversion, grayscale correction, matrix processing and result generation. Grayscale correction and matrix processing use algorithms well known to those skilled in the art. The procedures can be implemented by the face recognition system 10 illustrated in FIG. 1. And FIG. 3 is described in combination with FIG. 1 and FIG. 2.

In block 301, the grayscale camera 11 captures a grayscale image 201 of a face, and the infrared camera 12 captures an infrared image 203 of the face simultaneously with the grayscale camera 11. In one embodiment, both the grayscale camera 11 and the infrared camera 12 capture the facial image at a specified frequency, for example, 2 to 3 frames per second. Both the grayscale image 201 and the infrared image 203 are sent to a processor 13 in the face recognition system 10.

In block 302, the processor 13 converts the grayscale image 201 captured by the grayscale camera 11 to a grayscale matrix 205, and converts the infrared image 203 captured by the infrared camera 12 to an infrared matrix 207. Specifically, each image is divided into N frames, wherein N is an integer and depends on the parameters of the grayscale camera 11 or the infrared camera 12. For example, N may be in a range from 12 to 36. Three to four frames are selected out of the N frames as the key frames. For example, the selection can be made in terms of a time interval. The image with the selected three to four frames is gray scaled by converting the image to a 16-scale picture, that is, color information of each pixel can be represented by a 4-bit storage unit. Thus, each image is converted to a matrix. For example, a picture with a size of 800*600 can be converted to a matrix with a scale of 800*600, and each element of the matrix takes up a 4-bit storage unit. The process is known as the image conversion.

In block 303, the processor 13 extracts a feature matrix 209 from the grayscale matrix 205 and the infrared matrix 207 with a series of pre-stored algorithms. The feature matrix 209 represents the facial information. More specifically, as described above, the grayscale image 201 is converted to the grayscale matrix 205 and the infrared image 203 is converted to the infrared matrix 207. And the feature matrix 209 is derived by a characterization processing on the grayscale matrix 205 and the infrared matrix 207.

Advantageously, due to differences in light intensity, the grayscale image 201 captured by the grayscale camera 11 has color aberration compared with the actual image, which can affect the result of face recognition. By characterization processing on the grayscale matrix 205 and the infrared matrix 207, the impact of light on the image can be minimized since the feature matrix 209 includes information of both an infrared image and a visible image. And a more accurate result of face recognition can be achieved. The process is known as the grayscale correction, which is one of the advantages of the face recognition system and the method thereof according to the present teaching.

In block 304, the processor 13 computes a similarity value 213 by comparing the feature matrix 209 with multiple feature matrices 211 of predetermined facial information pre-stored in the feature database unit 14 The process is known as the matrix processing.

In block 305, the processor 13 outputs the result of face recognition. More specifically, the face is recognized according to the similarity value 213. In one embodiment, the person with the face is unauthorized if the similarity value 213 is less than a predetermined threshold, and is authorized if the similarity value 213 is greater than or equal to the predetermined threshold. The process is known as result generation.

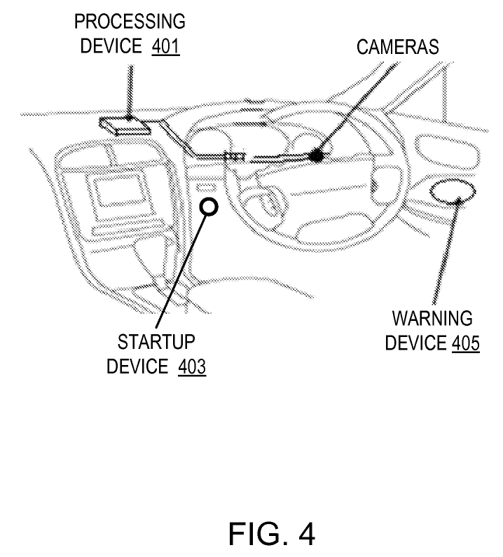

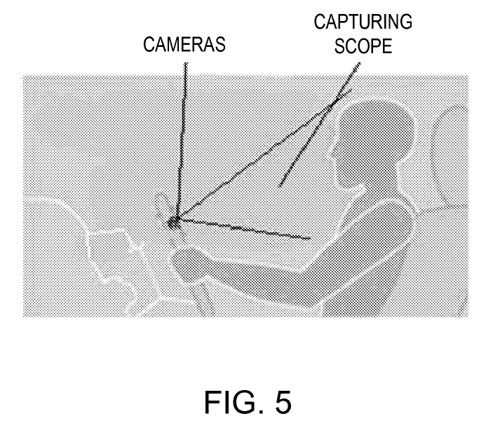

Furthermore, the face recognition system and the method thereof according to the present teaching can be applied to an automobile for automatically identifying the identity of a driver. For example, as shown in FIG. 4, a grayscale camera and an infrared camera are installed on a steering wheel of an automobile, a processing device 401 is installed on the plane in the front of the automobile, a startup device 403 is installed besides the steering wheel, and a warning device 405 is installed in a door of the automobile. Though, FIG. 4 shows a particular location for placement of each device, and the devices can be placed in other locations on the automobile. FIG. 5 shows an application scenario of an access control system by face recognition in an automobile, according to one embodiment of the present disclosure.

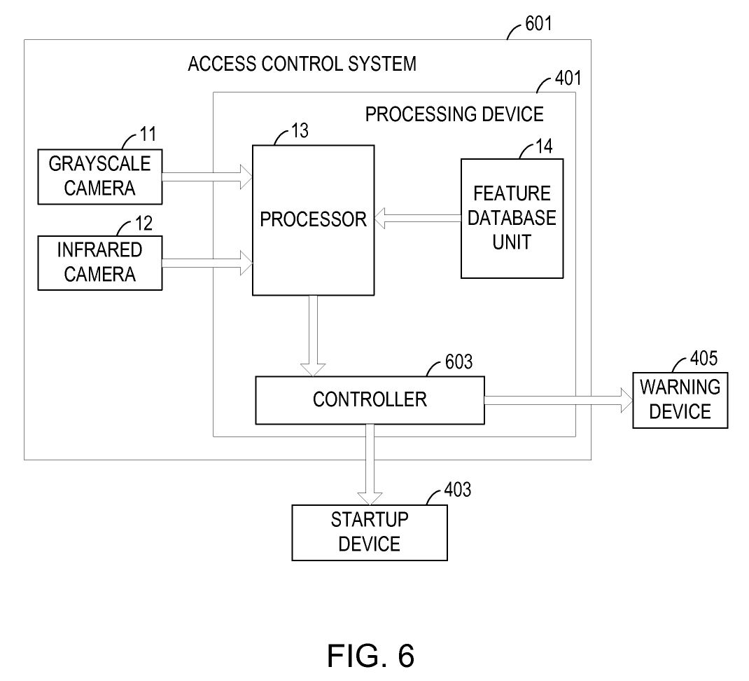

FIG. 6 illustrates a block diagram of an access control system by face recognition in an automobile, according to one embodiment of the present disclosure. The face recognition system in FIG. 1 is included in the access control system in FIG. 6. Elements that are labeled the same as in FIG. 1 and FIG. 4 have similar functions and will not be repetitively described herein for purposes of brevity and clarity. FIG. 6 is described in combination with FIG. 4 and FIG. 5.

The access control system 601 includes a grayscale camera 11, an infrared camera 12 and the processing device 401 The processing device 401 further includes a processor 13, a feature database unit 14 and a controller 603. The access control system 601 controls the startup device 403 and the warning device 405 by using the face recognition process to identify the identity of a driver of an automobile.

The grayscale camera 11 and the infrared camera 12 capture the facial image of the driver simultaneously, immediately after he/she enters the driving cab. The grayscale camera and the infrared camera may be activated by a motion sensor placed inside the automobile. In one embodiment, both the grayscale camera 11 and the infrared camera 12 capture the facial image at a specified frequency, for example, 2 to 3 frames per second. The processor 13 converts the image from the grayscale camera 11 and the image from the infrared camera 12 to a grayscale matrix and an infrared matrix, respectively, extracts a feature matrix from the two converted matrices, and computes a similarity value by comparing the extracted feature matrix with multiple feature matrices representing facial information of authorized drivers which are pre-stored in the feature database unit 14, so as to derive the result of face recognition and identify the identity of the driver.

More specifically, the identity of the driver is identified according to the similarity value. In one embodiment, the driver is unauthorized if the similarity value is less than a predetermined threshold, and is authorized if the similarity value is greater than or equal to the predetermined threshold. The result of face recognition is sent to the controller 601 by the processor 13. The controller 601 controls the startup device 403 and the warning device 405, according to the result of face recognition. More specifically, if the driver is authorized, the startup device 403 is enabled by the controller 601 and the automobile can be started by an operation on the startup device 403. Otherwise, the startup device 403 is disabled by the controller 601, the automobile cannot be started, and a warning signal is generated by the warning device 405 under the control of the controller 601.

The grayscale camera, the infrared camera, the processing device, the startup device, and the warning device can also be installed in other suitable positions of the automobile. Compared with the conventional access system in an automobile controlled by a key, the access control system by face recognition in one embodiment of the present teaching is much safer and more convenient. With the access control system by face recognition, an automobile can be started without a key, and the risk of the automobile being stolen can be greatly reduced.

The access control system in one embodiment of the present teaching can also be used in an anti-theft device, to recognize people who are allowed to drive the automobile and control a warning device to generate a warning signal. The warning signal may be sent as a text message to the user's mobile device or to a remote monitoring station.

While the foregoing description and drawings represent embodiments of the present teaching, it will be understood that various additions, modifications and substitutions may be made therein without departing from the spirit and scope of the principles of the present teaching as defined in the accompanying claims. One skilled in the art will appreciate that the teaching may be used with many modifications of form, structure, arrangement, proportions, materials, elements, and components and otherwise, used in the practice of the teaching, which are particularly adapted to specific environments and operative requirements without departing from the principles of the present teaching. The presently disclosed embodiments are therefore to be considered in all respects as illustrative and not restrictive, the scope of the teaching being indicated by the appended claims and their legal equivalents, and not limited to the foregoing description.

We claim:

1. An access control system in an automobile, comprising:
a grayscale camera, configured to capture a grayscale image of the face of a driver;
an infrared camera, configured to capture an infrared image of the face of said driver simultaneously with said grayscale camera; and
a processing device, coupled to said grayscale camera and said infrared camera, comprising:
a processor, configured to receive the grayscale image captured by the grayscale camera and the infrared image captured by the infrared camera, convert the grayscale image and the infrared image to a grayscale matrix and an infrared matrix respectively, extract a feature matrix from the grayscale matrix and the infrared matrix, and compute a similarity value by comparing the feature matrix with a plurality of feature matrices representing facial information of authorized drivers to derive a result of face recognition; and
a controller, configured to receive the result of face recognition and control a startup device and a warning device of the automobile according to the result of face recognition.

2. The access control system of claim 1, wherein the plurality of feature matrices representing facial information of authorized drivers are pre-stored in a feature database unit.

3. The access control system of claim 1, wherein the driver is unauthorized if the similarity value is less than a predetermined threshold.

4. The access control system of claim 1, wherein the driver is authorized if the similarity value is greater than or equal to a predetermined threshold.

5. The access control system of claim 1, wherein the startup device is enabled by the controller and the automobile is started by the startup device if the driver is authorized according to the similarity value.

6. The access control system of claim 1, wherein the controller disables the startup device and generates a warning signal if the driver is unauthorized according to the similarity value.

7. The access control system of claim 1, wherein the grayscale camera captures the grayscale image at a frequency of 2 to 3 frames per second.

8. The access control system of claim 1, wherein the infrared camera captures the infrared image at a frequency of 2 to 3 frames per second.

9. The access control system of claim 1, wherein the grayscale camera and the infrared camera are installed on a steering wheel of the automobile.

10. A face recognition system, comprising:
a grayscale camera, configured to capture a grayscale image of a face;
an infrared camera, configured to capture an infrared image of the face simultaneously with the grayscale camera; and
a processor, configured to receive the grayscale image captured by the grayscale camera and the infrared image captured by said infrared camera, convert the grayscale image and the infrared image to a grayscale matrix and an infrared matrix respectively, extract a feature matrix from the grayscale matrix and the infrared matrix, and compute a similarity value by comparing the feature matrix with a plurality of feature matrices of predetermined facial information to derive the result of face recognition.

11. The face recognition system of claim 10, wherein the plurality of feature matrices of predetermined facial information are pre-stored in a feature database unit.

12. The face recognition system of claim 10, wherein a person with the face is unauthorized if the similarity value is less than a predetermined threshold.

13. The face recognition system of claim 10, wherein a person with the face is authorized if the similarity value is greater than or equal to a predetermined threshold.

14. The face recognition system of claim 10, wherein the grayscale camera captures the grayscale image at a frequency of 2 to 3 frames per second.

15. The face recognition system of claim 10, wherein the infrared camera captures the infrared image at a frequency of 2 to 3 frames per second.

16. A method of face recognition, comprising the steps of:
capturing a grayscale image of a face by a grayscale camera and an infrared image of the face by an infrared camera simultaneously;
sending the grayscale image and the infrared image to a processor;
converting, by the processor, the grayscale image to a grayscale matrix and the infrared image to an infrared matrix;
extracting a feature matrix from the grayscale matrix and the infrared matrix;
computing, by the processor, a similarity value by comparing the feature matrix with a plurality of feature matrices; and
outputting a result of face recognition according to the similarity value.

17. The method of face recognition of claim 16, wherein a person with the face is unauthorized if the similarity value is less than a predetermined threshold.

18. The method of face recognition of claim 16, wherein a person with the face is authorized if the similarity value is greater than or equal to a predetermined threshold.

19. The method of face recognition of claim 16, wherein the grayscale camera captures the grayscale image at a frequency of 2 to 3 frames per second.

20. The method of face recognition of claim 16, wherein the infrared camera captures the infrared image at a frequency of 2 to 3 frames per second.
